(19) United States
(12) Patent Application Publication
(10) Pub. No.: US 2004/0200995 A1
(43) Pub. Date: Oct. 14, 2004

(54) Light absorbing and emitting composition with granules

(76) Inventor: Jacky Peng, Taipei City (TW)

Correspondence Address: Jack PENG, PO Box 82-144, Taipei, TW

(21) Appl. No.: 09/985,993

(22) Filed: Nov. 7, 2001

(51) Int. Cl. C09K 11/06

(52) U.S. Cl. 252/301.16; 252/582; 252/301.35; 428/690; 428/913

(57) ABSTRACT

A light absorbing and emitting composition consisting of a transparent or translucent substrate and a plurality of light absorbing polymer granules which are well mixed together to a composition for making articles with desired shapes, whereby ten or hundreds of light absorbing polymer granules within the transparent or translucent substrate can emit brighter light for a longer period, thereby producing much variation in visual effect.

### BACKGROUND OF THE INVENTION

1. Technical Field of the Invention

This invention is related to a light absorbing and emitting composition and in particular to one which can increase light emitting variations and prolong the time of emitting light. Furthermore, it has a fascinating visual effect.

2. Description of the Prior Art

The conventional light absorbing and emitting body is made into various kinds of things, such as animal shaped toys, small decorations, key rings, hanging decorations, etc. The conventional light absorbing and emitting body as shown in FIGS. 1 and 2 is generally made of plastic and powder light absorbing and emitting material, which are mixed together and then processed with injection molding to form different design-shaped bodies. Such a light absorbing and emitting body 3 will absorb light in bright circumstances and emit light in the dark.

However, although such a light absorbing and emitting body will emit light in the dark, it cannot absorb light while emitting light. Hence, the time of emitting light will be very short. This result is not desirable.

Therefore, it is an object of the present invention to provide a light absorbing and emitting composition with granules which can obviate and mitigate the above-mentioned drawbacks.

### SUMMARY OF THE INVENTION

This invention is related to a light absorbing and emitting composition and in particular to one which can increase light emitting variations and prolong the time of emitting light.

It is the primary object of the present invention to provide a light absorbing and emitting composition which consists of a transparent or translucent substrate and a plurality of light absorbing polymer granules which are well mixed together to a composition for making articles with desired shapes, whereby ten or hundreds of light absorbing polymer granules within the transparent or translucent substrate can emit brighter light for a longer period, thereby producing much variation in visual effect.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional light absorbing and emitting member;

FIG. 2 is a side view of the conventional light absorbing and emitting member;

FIG. 3 is a perspective view of the present invention;

FIG. 4 is a side view of the present invention;

FIG. 5 is another preferred embodiment of the present invention;

FIG. 6 is another preferred embodiment of the present invention;

FIG. 7 is another preferred embodiment of the present invention;

FIG. 8 is another preferred embodiment of the present invention; and

FIG. 9 is another preferred embodiment of the present invention.

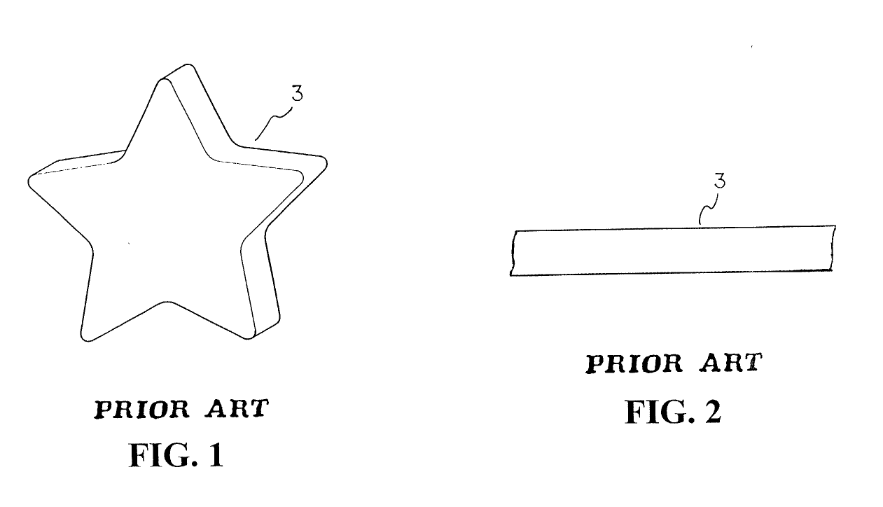

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

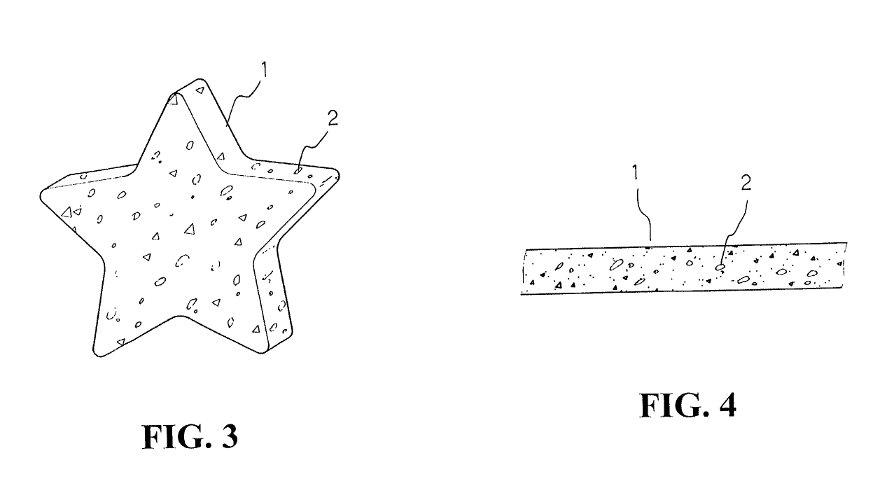

Referring to FIGS. 3 and 4, the light absorbing and emitting composition according to the present invention consists essentially of a substrate 1 and a plurality of light absorbing polymer granules 2.

The substrate 1 includes liquid or solid material and may be made of flexible material such as plastic, or rigid material such as acrylic, glass or ceramic. Transparent or translucent material is preferred in order to increase the intensity of light emitted by the light absorbing polymer granules 2.

The light absorbing polymer granules 2 are formed by grinding light absorbing material which can absorb light in the bright and emit light in the dark and can absorb light at the same time of emitting light thereby prolonging the time of emitting light and increasing the intensity of light. Furthermore, the light absorbing polymer granules 2 may be mixed with non-transparent elements.

The substrate 1 and the light absorbing granules 2 are well mixed together to form a body which is then possessed to make articles of desired shapes such as a star-shaped article as shown in FIG. 3.

By the above-mentioned structure, tens or hundreds of light absorbing polymer granules 2 are mixed with transparent or translucent substrate 1 to form a light absorbing and emitting body, so that the light absorbing granules will emit brighter light for a longer period, thereby producing much variation in visual effect.

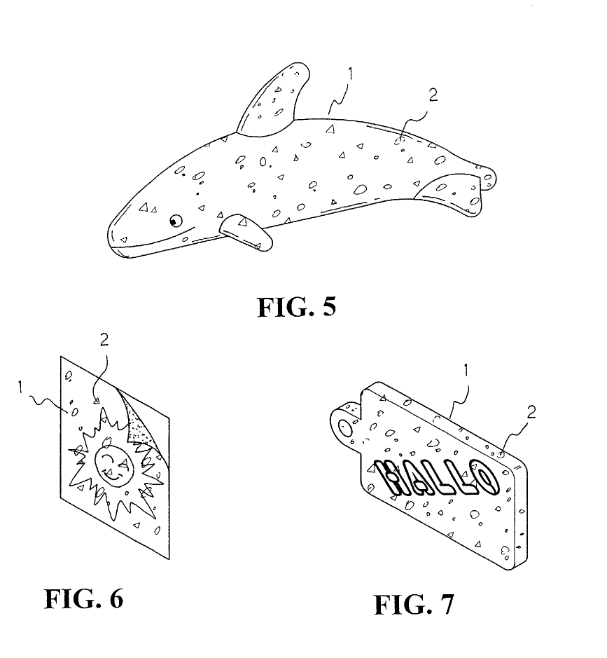

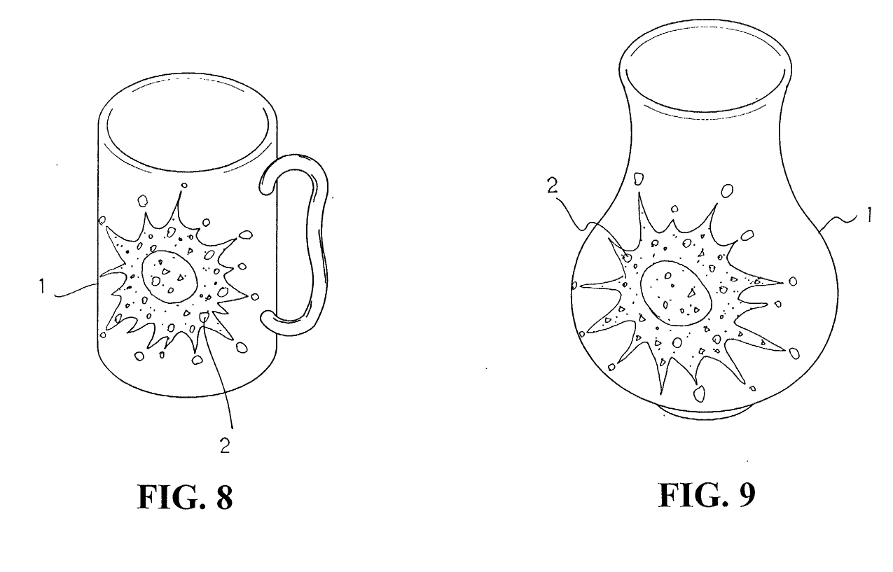

The application of the present invention has no limit in its application, and can be used with other plastic articles, such as small decorations and key rings as shown in FIGS. 5 and 7, and ceramic and glass articles such as cups and vases, as shown in FIGS. 8 and 9, so that a portion or the whole body of the articles can absorb and emit light. Furthermore, the present invention can be mixed with printing ink so that it can be applied to various kinds of stationery, toys, and decorations by means of printing, so as to provide local light emitting visual effect, making it look different from other similar objects.

Moreover, various kinds of light-colored printing inks can be mixed with the light absorbing granules so as to provide more fascinating visual effect, which can satisfy the consumer's need.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A light absorbing and emitting composition consisting of a transparent or translucent substrate and a plurality of light absorbing polymer granules which are well mixed together to a composition for making articles with desired shapes, whereby ten or hundreds of light absorbing polymer granules within the transparent or translucent substrate can emit brighter light for a longer period, thereby producing much variation in visual effect.

2. The light absorbing and emitting composition as claimed in claim 1, wherein said light absorbing polymer granules is mixed with printing ink.

3. The light absorbing and emitting composition as claimed in claim 1, wherein said transparent or translucent substrate is made of plastic, acrylic, glass or ceramic.

4. The light absorbing and emitting composition as claimed in claim 1, wherein said light absorbing polymer granules is mixed with non-transparent elements.
